(19) United States
(12) Patent Application Publication
(10) Pub. No.: US 2016/0350751 A1
(43) Pub. Date: Dec. 1, 2016

(54) Provisioning a Mobile Device with a Code Generation Key to Enable Generation of One-Time Passcodes

(71) Applicant: Bank of America Corporation, Charlotte, NC (US)

(72) Inventors: Andrew T. Keys, Albany, OR (US); Kapil Pruthi, Bothell, WA (US); Xianhong Zhang, Issaquah, WA (US); Tao Huang, Bellevue, WA (US)

(21) Appl. No.: 14/722,555

(22) Filed: May 27, 2015

(51) Int. Cl. G06Q 20/38; H04W 12/06; G06Q 20/32; H04W 12/04

(52) U.S. Cl. CPC G06Q 20/3829; H04W 12/04; H04W 12/06; G06Q 20/3223; G06Q 20/385; G06Q 20/3226

(57) ABSTRACT

Methods, systems, and computer-readable media for provisioning a mobile device with a code generation key to enable generation of one-time passcodes are presented. In some embodiments, a computer system may receive, from a mobile computing device associated with a customer of a financial institution, a request to register a passcode generator on the mobile computing device. Subsequently, based on receiving the request, the computer system may authenticate a user of the mobile computing device to an online banking user account associated with the customer. Then, based on authenticating the user to the online banking user account, the computer system may generate a code generation key configured to be used by the passcode generator. Next, the computer system may store the code generation key in a key database. Subsequently, the computer system may send, to the mobile computing device, the code generation key to provision the passcode generator.

### BACKGROUND

Aspects of the disclosure relate to computer hardware and software. In particular, one or more aspects of the disclosure generally relate to computer hardware and software for provisioning a mobile device with a code generation key to enable generation of one-time passcodes (OTPs).

Large organizations, such as financial institutions, may serve many customers. Increasingly, many customers of financial institutions and other large institutions are using online portals provided by such organizations to interact with the organizations. For example, an organization may operate an online portal to provide its customers with access to customer account information, customer product information, customer preferences information, other types of customer information, and/or other information.

As organizations provide customers with access to online portals, and as customers increasingly use such portals, it may be increasingly important to ensure the safety and security of the customer information and/or other information that may be accessible via such portals. In many instances, however, it may be difficult to provide customers and/or other authorized users with efficient, easy-to-use, and convenient access to a customer portal and the information available via such a customer portal, while also ensuring the security of the portal and the information available via the portal and pursuing ever greater levels of security for the portal and its associated information.

### SUMMARY

Aspects of the disclosure relate to various systems and techniques that provide effective, efficient, scalable, and convenient ways of securing customer portals and customer information, particularly in ways that involve provisioning a mobile device with a code generation key to enable generation of one-time passcodes on the mobile device.

For example, in some instances, an organization, such as a financial institution, may secure a customer portal using various types of login credentials, such as a username, a password, a one-time passcode, one or more biometrics, or the like. For instance, in addition to requiring that a user provide a username and password when accessing a customer portal, an organization also may require the user to provide a one-time passcode when initially connecting the customer portal, when accessing the customer portal from a new device, when requesting high-risk transactions and/or other types of transactions via the customer portal, and/or in other specific instances.

In some instances, however, a one-time passcode may be generated by an organization computer server and transmitted to a customer device on-demand and for immediate and/or time-limited use by the customer. For example, the one-time passcode may be transmitted to the customer when the customer is requesting to access a customer portal (e.g., on the customer device or on another computing device), and the one-time passcode may expire after a relatively short predetermined period of time (e.g., ten minutes). In these instances, if the customer does not receive or use the one-time passcode within the predetermined period of time, the one-time passcode may expire and/or otherwise might be rendered unusable for accessing the customer portal.

This situation, however, can pose an issue for the customer if, for instance, the customer is an area where their customer device does not have signal reception and/or data service. For example, if the customer is in an area in which their customer device does not receive cellular service (e.g., if they are traveling internationally) and an organization server sends a one-time passcode to the customer device via a text message (e.g., via a Short Messaging Service (SMS) message, via a Multimedia Messaging Service (MMS) message, or the like), the customer might not be able to receive the one-time passcode and accordingly might not be able to access the organization's customer portal. In addition, although the customer may be able to obtain and/or use a physical token generator which may, for instance, provide the customer with one-time passcodes and which might not be reliant on cellular service or other data service, such a physical token generator may have increased costs and other usability issues, such as a limited battery life.

By implementing one or more aspects of the disclosure, one or more of these and/or other issues may be overcome. For example, in accordance with one or more aspects of the disclosure, a customer of a financial institution may be able to use a one-time passcode generator software application on his or her mobile computing device to generate one or more one-time passcodes (e.g., even if the mobile computing device is offline), which then may be used by the customer in accessing the customer's online banking account and/or conducting transactions via an online banking portal provided by the financial institution. In particular, the customer may be able to download and/or install a one-time passcode generator (which may, e.g., be a standalone software application or be incorporated into a mobile banking application that is provided by the financial institution and that also provides online banking functionality) to generate one or more one-time passcodes on the customer's mobile computing device, even if the customer's mobile computing device lacks signal reception or data service or is otherwise unable to connect to and/or receive messages from the financial institution's computer server. As discussed in greater detail below, the customer may initially register the one-time passcode generator with the financial institution computer server, and the financial institution computer server may provision the one-time passcode generator with a secret key during a registration process. The one-time passcode generator on the customer mobile device may persist and/or maintain a copy of the secret key for use in generating one or more one-time passcodes, and the financial institution computer server may persist and/or maintain a copy of the secret key for use in validating one or more one-time passcodes generated by the one-time passcode generator on the customer mobile device. Such one-time passcodes may be generated using time-based and/or counter-based one-time passcode generation algorithms, including one or more one-time passcode generation algorithms that are defined by, standardized by, compliant with, and/or otherwise associated with Initiative for Open Authentication (OATH) standards.

Advantageously, one or more aspects of the disclosure may enable an organization and its customers to use one-time passcodes to securely access customer portals, including the customer information and/or functions that may be available via such portals, even in instances in which a customer's mobile device cannot receive messages from an organization server and/or otherwise lacks network access to communication with such an organization server.

In accordance with one or more embodiments, an online banking computing platform having at least one processor, a memory, and a communication interface may receive, via the communication interface, and from a mobile computing device associated with a customer of a financial institution, a request to register a passcode generator on the mobile computing device. Subsequently, based on receiving the request to register the passcode generator on the mobile computing device, the online banking computing platform may authenticate a user of the mobile computing device to an online banking user account associated with the customer of the financial institution. Then, based on authenticating the user of the mobile computing device to the online banking user account associated with the customer of the financial institution, the online banking computing platform may generate a code generation key configured to be used by the passcode generator on the mobile computing device in generating one or more one-time passcodes on the mobile computing device. Next, the online banking computing platform may store the code generation key in a key database configured to maintain one or more secret keys for validating one-time passcodes generated by customers of the financial institution. Subsequently, the online banking computing platform may send, via the communication interface, and to the mobile computing device associated with the customer of the financial institution, the code generation key to provision the passcode generator on the mobile computing device associated with the customer of the financial institution with the code generation key.

In some embodiments, authenticating the user of the mobile computing device to the online banking user account associated with the customer of the financial institution may include: prompting the user of the mobile computing device to provide one or more login credentials associated with the online banking user account associated with the customer of the financial institution; and validating the one or more login credentials provided by the user of the mobile computing device. In some instances, the one or more login credentials associated with the online banking user account associated with the customer of the financial institution may include a username and password. Additionally or alternatively, the one or more login credentials associated with the online banking user account associated with the customer of the financial institution may include a one-time passcode provided to a registered device associated with the customer of the financial institution. Additionally or alternatively, the one or more login credentials associated with the online banking user account associated with the customer of the financial institution may include one or more biometrics associated with the customer of the financial institution.

In some embodiments, the online banking computing platform may receive, via the communication interface, and from a customer computing device, a request to access the online banking user account associated with the customer of the financial institution. Subsequently, based on receiving the request to access the online banking user account associated with the customer of the financial institution, the online banking computing platform may prompt the customer computing device to provide a one-time passcode generated by the passcode generator on the mobile computing device.

In some embodiments, the online banking computing platform may receive, via the communication interface, and from the customer computing device, a first one-time passcode generated by the passcode generator on the mobile computing device. Subsequently, the online banking computing platform may validate the first one-time passcode generated by the passcode generator on the mobile computing device based on the code generation key stored in the key database. Then, based on validating the first one-time passcode generated by the passcode generator on the mobile computing device based on the code generation key stored in the key database, the online banking computing platform may provide the customer computing device with access to the online banking user account associated with the customer of the financial institution.

In some instances, providing the customer computing device with access to the online banking user account associated with the customer of the financial institution may include providing financial account information to the customer computing device via an online banking portal. In some instances, providing the customer computing device with access to the online banking user account associated with the customer of the financial institution may include processing one or more transaction requests received from the customer computing device via the online banking portal. In some instances, at least one transaction request of the one or more transaction requests received from the customer computing device via the online banking portal may include a request for a restricted transaction that requires validation of the first one-time passcode generated by the passcode generator on the mobile computing device.

In some instances, the customer computing device may be the mobile computing device associated with the customer of the financial institution. In other instances, the customer computing device may be a computing device different from the mobile computing device associated with the customer of the financial institution.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for provisioning a mobile device with a code generation key to enable generation of one-time passcodes in accordance with one or more example embodiments;

FIGS. 4A-4D depict an illustrative event sequence for provisioning a mobile device with a code generation key to enable generation of one-time passcodes in accordance with one or more example embodiments;

FIGS. 5-10 depict example graphical user interfaces for provisioning a mobile device with a code generation key to enable generation of one-time passcodes in accordance with one or more example embodiments; and

FIG. 11 depicts an illustrative method for provisioning a mobile device with a code generation key to enable generation of one-time passcodes in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

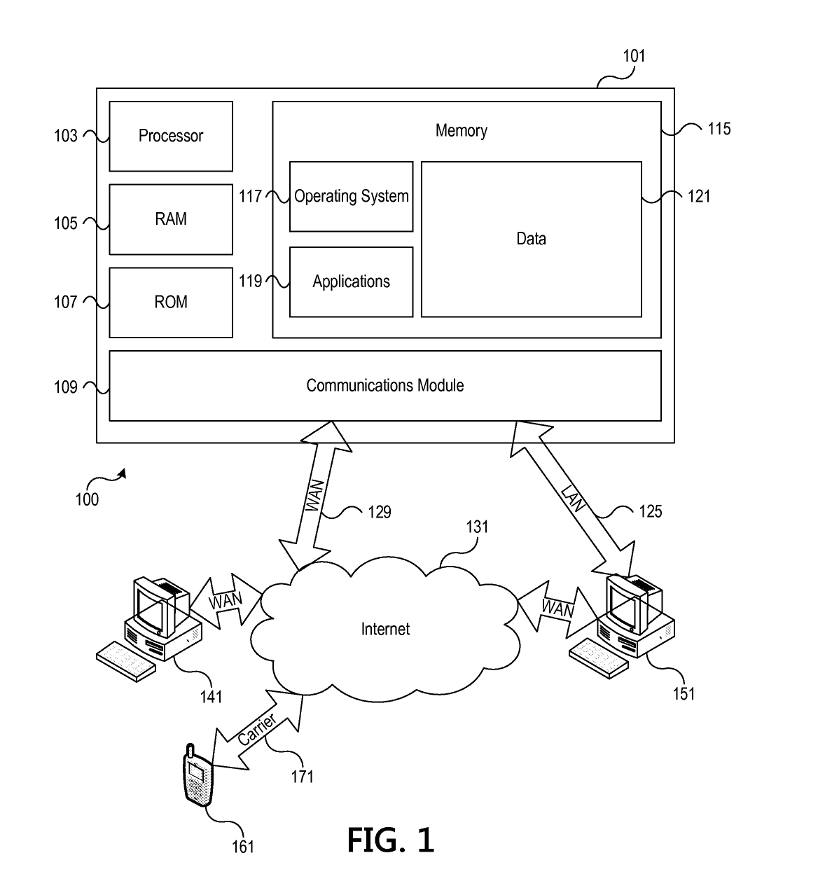

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks) are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

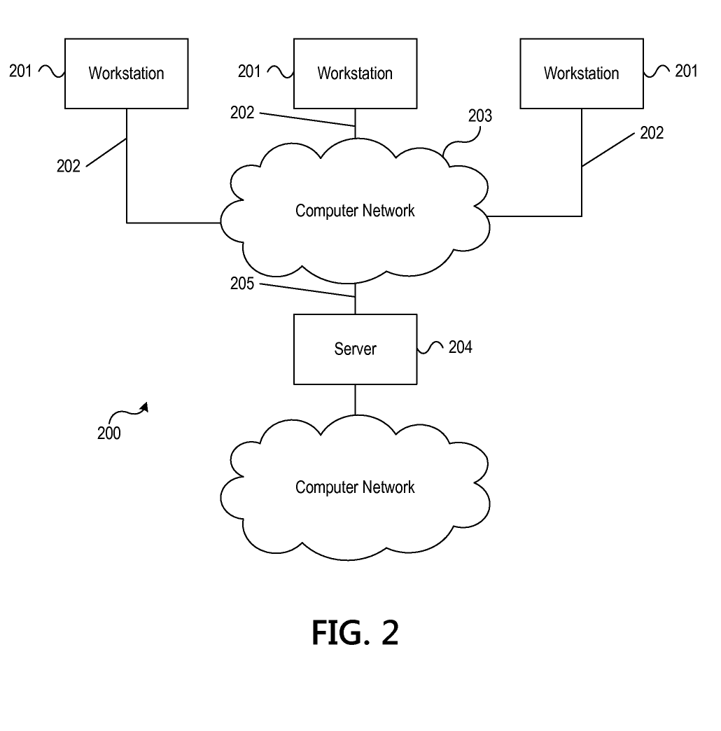

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

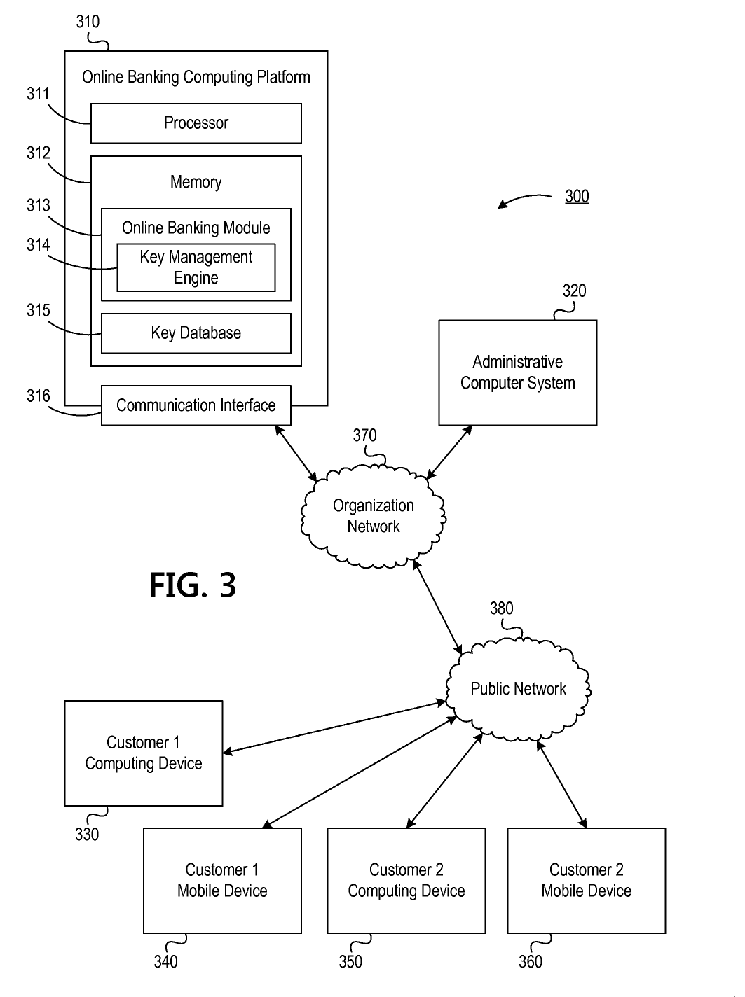

FIG. 3 depicts an illustrative computing environment for provisioning a mobile device with a code generation key to enable generation of one-time passcodes in accordance with one or more example embodiments. Referring to FIG. 3, computing environment 300 may include one or more computing devices. For example, computing environment 300 may include an administrative computer system 320, a first customer computing device 330, a first customer mobile device 340, a second customer computing device 350, and a second customer mobile device 360. Administrative computer system 320 may, for example, be used by and/or configured to be used by an administrative user of an organization, such as an administrative user of a financial institution and/or an administrative user of a particular business unit of a financial institution. Customer computing device 330 may, for example, be used by and/or configured to be used by a first customer of an organization, such as a particular customer of a financial institution, and customer mobile device 340 may, for example, also be used by and/or configured to be used by the first customer of the organization, such as the same customer of the financial institution. Customer computing device 350 may, for example, be used by and/or configured to be used by a second customer of an organization, such as another customer of the financial institution (who may, e.g., be different from the customer who may use customer computing device 330 and/or customer mobile device 340), and customer mobile device 360 may, for example, also be used by and/or configured to be used by the second customer of the organization, such as the same customer of the financial institution who may use customer computing device 350. In some instances, a passcode generator may be installed on and/or executed on customer mobile device 340 and/or customer mobile device 360 and may be used in generating one or more one-time passcodes when a user of customer computing device 330, customer mobile device 340, customer computing device 350, and/or customer mobile device 360 is accessing and/or requesting to access a customer portal associated with an organization, such as an online banking portal provided by a financial institution, as illustrated in greater detail below.

Administrative computer system 320, customer computing device 330, customer mobile device 340, customer computing device 350, and customer mobile device 360 may be any type of computing device capable of receiving a user interface, receiving input via the user interface, and communicating the received input to one or more other computing devices. For example, administrative computer system 320, customer computing device 330, customer mobile device 340, customer computing device 350, and customer mobile device 360 may be a server computer, a desktop computer, laptop computer, tablet computer, smart phone, or the like. As noted above, and as illustrated in greater detail below, any and/or all of administrative computer system 320, customer computing device 330, customer mobile device 340, customer computing device 350, and customer mobile device 360 may, in some instances, be special-purpose computing devices configured to perform specific functions.

Computing environment 300 also may include one or more computing platforms. For example, computing environment 300 may include online banking computing platform 310. Online banking computing platform 310 may include one or more computing devices configured to perform one or more of the functions described herein. For example, online banking computing platform 310 may include one or more computers (e.g., laptop computers, desktop computers, servers, server blades, or the like).

Computing environment 300 also may include one or more networks, which may interconnect one or more of online banking computing platform 310, administrative computer system 320, customer computing device 330, customer mobile device 340, customer computing device 350, and customer mobile device 360. For example, computing environment 300 may include organization network 370 and public network 380. Organization network 370 and/or public network 380 may include one or more sub-networks (e.g., LANs, WANs, or the like). Organization network 370 may be associated with a particular organization (e.g., a corporation, financial institution, educational institution, governmental institution, or the like) and may interconnect one or more computing devices associated with the organization. For example, online banking computing platform 310 and administrative computer system 320 may be associated with an organization (e.g., a financial institution), and organization network 370 may be associated with and/or operated by the organization, and may include one or more networks (e.g., LANs, WANs, VPNs, or the like) that interconnect online banking computing platform 310 and administrative computer system 320 and one or more other computing devices and/or computer systems that are used by, operated by, and/or otherwise associated with the organization. Public network 380 may connect organization network 370 and/or one or more computing devices connected thereto (e.g., online banking computing platform 310, administrative computer system 320) with one or more networks and/or computing devices that are not associated with the organization. For example, customer computing device 330, customer mobile device 340, customer computing device 350, and customer mobile device 360 might not be associated with an organization that operates organization network 370 (e.g., because customer computing device 330, customer mobile device 340, customer computing device 350, and customer mobile device 360 may be owned and/or operated by one or more entities different from the organization that operates organization network 370, rather than being owned and/or operated by the organization itself or an employee or affiliate of the organization), and public network 380 may include one or more networks (e.g., the internet) that connect customer computing device 330, customer mobile device 340, customer computing device 350, and customer mobile device 360 to organization network 370 and/or one or more computing devices connected thereto (e.g., online banking computing platform 310, administrative computer system 320).

Online banking computing platform 310 may include one or more processors 311, memory 312, and communication interface 316. A data bus may interconnect processor(s) 311, memory 312, and communication interface 316. Communication interface 316 may be a network interface configured to support communication between online banking computing platform 310 and organization network 370 and/or one or more sub-networks thereof. Memory 312 may include one or more program modules having instructions that when executed by processor(s) 311 cause online banking computing platform 310 to perform one or more functions described herein and/or one or more databases that may store and/or otherwise maintain information which may be used by such program modules and/or processor(s) 311. For example, memory 312 may include online banking module 313, which may include instructions that when executed by processor(s) 311 cause online banking computing platform 310 to perform one or more functions described herein, such as instructions for provisioning a mobile device with a code generation key to enable generation of one-time passcodes, as illustrated in greater detail below. For instance, online banking module 313 may include executable instructions for and/or otherwise provide a key management engine 314, which may be used in generating one or more code generation keys (which may, e.g., be used to provision one or more mobile computing devices to enable such mobile computing devices to generate one or more one-time passcodes, as illustrated in greater detail below) and/or in validating one or more one-time passcodes received by online banking computing platform 310 (e.g., from one or more mobile computing devices that have been provisioned with one or more code generation keys, as illustrated in greater detail below). In addition, memory 312 may include a key database 315, which may store information identifying one or more previously generated code generation keys and/or information identifying one or more specific customer computing devices to which such code generation keys have been provided (e.g., by online banking computing platform 310 and/or key management engine 314) and/or other information used by online banking computing platform 310 and/or key management engine 314 (e.g., in generating one or more code generation keys, in validating one or more one-time passcodes, and/or in providing an online banking portal and/or managing access to such an online banking portal), as illustrated in greater detail below.

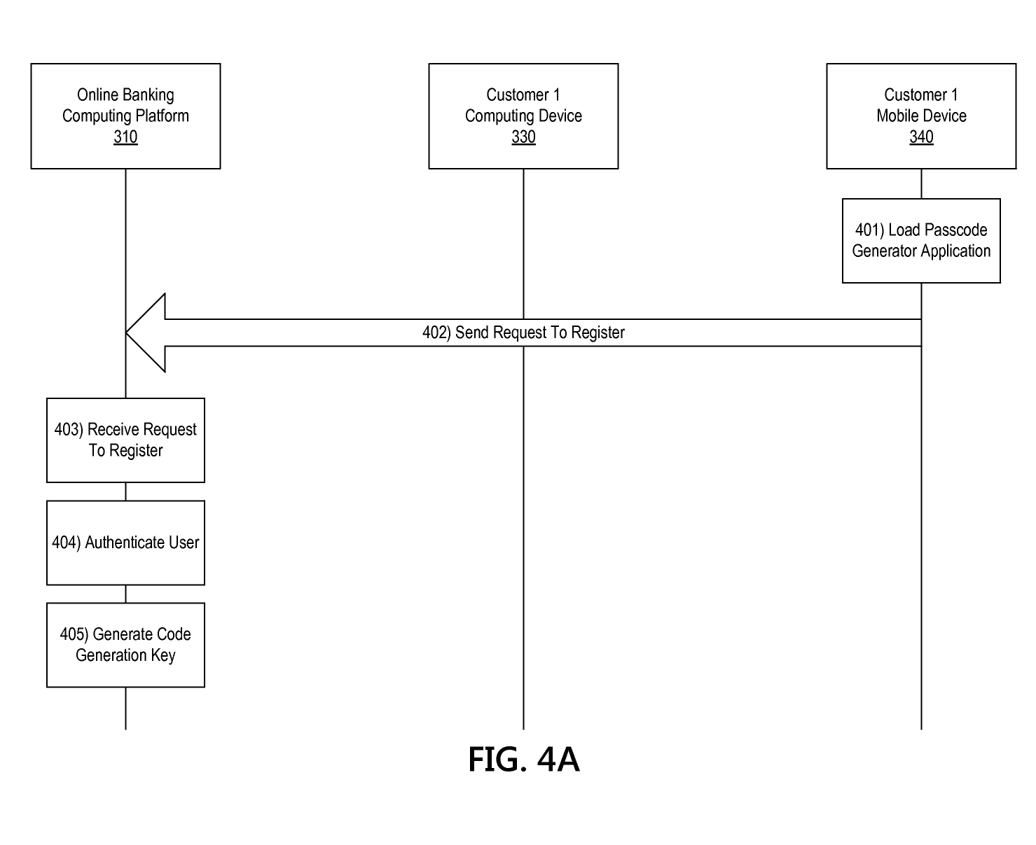

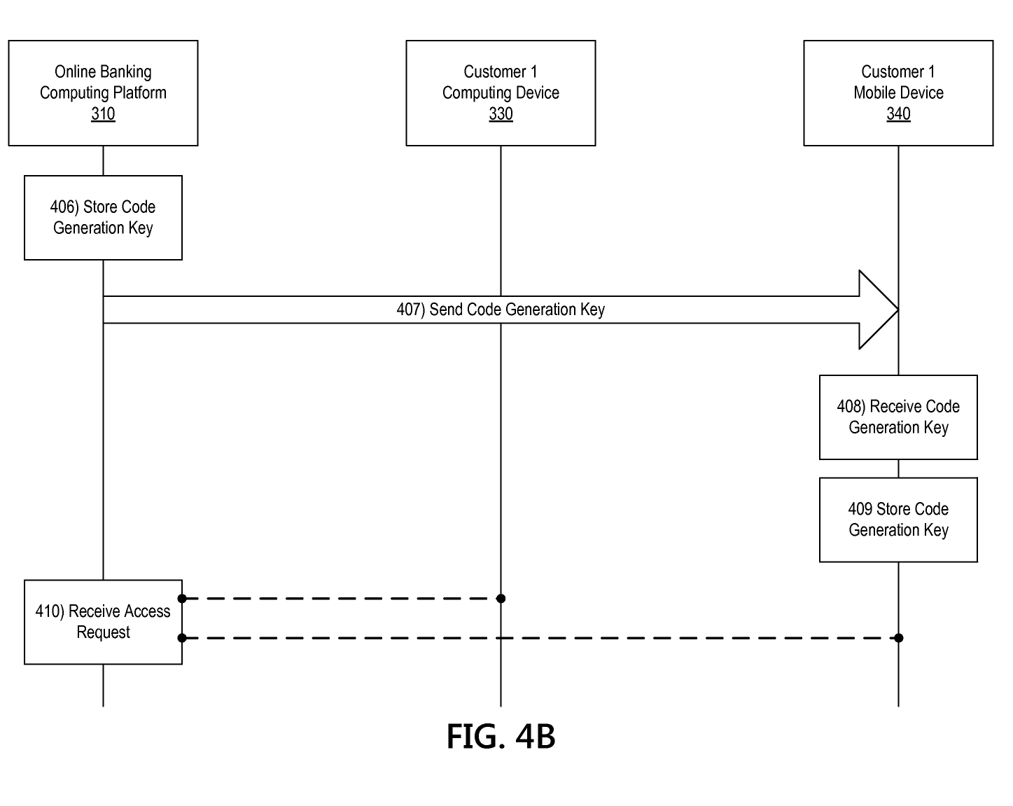

FIGS. 4A-4D depict an illustrative event sequence for provisioning a mobile device with a code generation key to enable generation of one-time passcodes in accordance with one or more example embodiments. Referring to FIG. 4A, at step 401, customer mobile device 340 may load a passcode generator application. For example, at step 401, customer mobile device 340 may download, install, execute and/or otherwise load a passcode generator application (which may, e.g., be provided by the financial institution operating online banking computing platform 310). In some instances, the passcode generator application may be incorporated into and/or otherwise part of a mobile banking application which may, for instance, be provided by the financial institution operating online banking computing platform 310 and/or which may provide one or more online banking functions (e.g., providing and/or presenting account balance information and/or transaction history information, providing funds transfer functions, providing bill payment functions, or the like) in addition to one-time passcode generation functions and/or other functions. In other instances, the passcode generator application may be a standalone application which may, for instance, only provide one-time passcode generation functions and which may be separate from a mobile banking application provided by the financial institution operating online banking computing platform 310. In some instances, in loading the passcode generator application, customer mobile device 340 may present one or more graphical user interfaces associated with the passcode generator application. For example, in loading the passcode generator application, customer mobile device 340 may display, cause to be displayed, and/or otherwise present a graphical user interface similar to graphical user interface 500, which is illustrated in FIG. 5. As seen in FIG. 5, graphical user interface 500 may include text and/or other information providing instructions for using the passcode generator application and/or prompting the user of customer mobile device 340 to register the passcode generator application (e.g., with online banking computing platform 310 and/or the financial institution operating online banking computing platform 310).

Referring again to FIG. 4A, at step 402, customer mobile device 340 may send a request to register to online banking computing platform 310. For example, at step 402, customer mobile device 340 may send a request to online banking computing platform 310 to register the passcode generator on customer mobile device 340 with online banking computing platform 310. Such a request may, for instance, initiate a provisioning process and allow the passcode generator on customer mobile device 340 to obtain a code generation key, which may enable the passcode generator on customer mobile device 340 to generate one or more one-time passcodes on customer mobile device 340, as illustrated in greater detail below. In some instances, customer mobile device 340 may send such a request to online banking computing platform 310 based on input received from the user of customer mobile device 340 requesting to register the passcode generator application on customer mobile device 340 with online banking computing platform 310 and/or based on one or more commands executed by the passcode generator application on customer mobile device 340.

At step 403, online banking computing platform 310 may receive the request to register from customer mobile device 340. For example, at step 403, online banking computing platform 310 may receive, via a communication interface (e.g., communication interface 316), and from a mobile computing device associated with a customer of a financial institution (e.g., customer mobile device 340), a request to register a passcode generator on the mobile computing device.

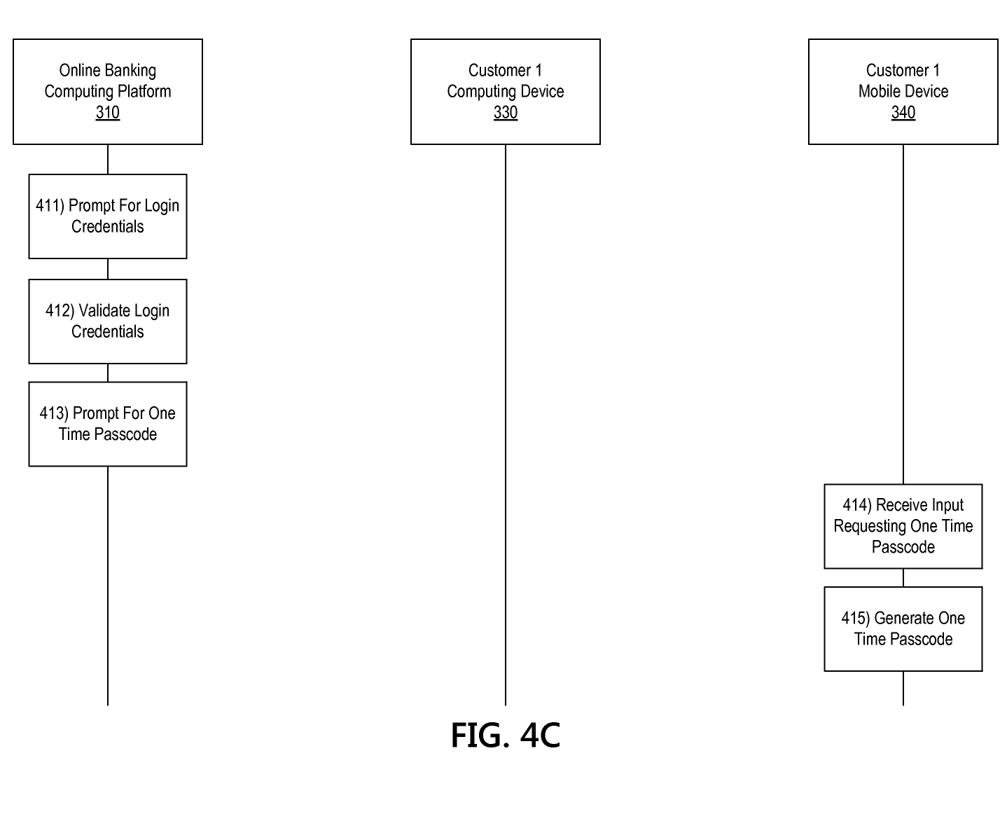

At step 404, online banking computing platform 310 may authenticate the user of customer mobile device 340. For example, based on receiving the request to register the passcode generator on the mobile computing device (e.g., at step 403), online banking computing platform 310 may, at step 404, authenticate a user of the mobile computing device (e.g., customer mobile device 340) to an online banking user account associated with the customer of the financial institution. In authenticating the user of customer mobile device 340 to an online banking user account, online banking computing platform 310 may, for instance, prompt customer mobile device 340 to provide, and/or cause customer mobile device 340 to present one or more prompts for, one or more login credentials for the online banking user account, such as a username, a password, a one-time passcode, one or more biometrics, and/or the like. If customer mobile device 340 and/or the user of customer mobile device 340 does not provide valid login credentials to online banking computing platform 310 in response to such prompts (e.g., after a predetermined number of attempts), online banking computing platform 310 may generate and/or send one or more error messages and the event sequence may end at step 404 (e.g., without online banking computing platform 310 generating a code generation key for the passcode generator application on customer mobile device 340). In some instances, in authenticating the user of customer mobile device 340, online banking computing platform 310 may cause customer mobile device 340 to present one or more graphical user interfaces for authenticating the user of customer mobile device 340 to the online banking user account. For example, online banking computing platform 310 may cause customer mobile device 340 to display, cause to be displayed, and/or otherwise present a graphical user interface similar to graphical user interface 600, which is illustrated in FIG. 6. As seen in FIG. 6, graphical user interface 600 may include text and/or other information providing instructions to the user of customer mobile device 340 regarding an authentication process and/or prompting the user of customer mobile device 340 to enter one or more authentication credentials, such as an online banking username, password, and/or the like. If customer mobile device 340 and/or the user of customer mobile device 340 provides valid login credentials to online banking computing platform 310 (e.g., at step 404), then the event sequence may continue on to at step 405, as discussed in greater detail below.

In some embodiments, authenticating the user of the mobile computing device to the online banking user account associated with the customer of the financial institution may include prompting the user of the mobile computing device to provide one or more login credentials associated with the online banking user account associated with the customer of the financial institution and validating the one or more login credentials provided by the user of the mobile computing device. For example, in authenticating the user of the mobile computing device (e.g., customer mobile device 340) to the online banking user account associated with the customer of the financial institution, online banking computing platform 310 may prompt the user of customer mobile device 340 to provide one or more login credentials associated with the online banking user account associated with the customer of the financial institution (e.g., by generating and/or sending one or more prompts to customer mobile device 340 that are configured to cause customer mobile device 340 to prompt the user of customer mobile device 340 to input and/or otherwise provide such login credentials for validation by customer mobile device 340 and/or online banking computing platform 310). In addition, online banking computing platform 310 may validate the one or more login credentials provided by the user of customer mobile device 340 (e.g., by matching, comparing, and/or otherwise checking the one or more login credentials provided by the user of customer mobile device 340 with one or more valid credentials for the online banking user account that are stored and/or otherwise maintained by online banking computing platform 310).

In some instances, the one or more login credentials associated with the online banking user account associated with the customer of the financial institution may include a username and password. For example, in authenticating the user of the mobile computing device (e.g., customer mobile device 340) to the online banking user account associated with the customer of the financial institution, online banking computing platform 310 may prompt the user of customer mobile device 340 to provide a username and a password for the online banking account that corresponds to the customer of the financial institution (e.g., by generating and/or sending one or more prompts to customer mobile device 340 that are configured to cause customer mobile device 340 to prompt the user of customer mobile device 340 to input and/or otherwise provide a username and a password and/or one or more other login credentials for validation by customer mobile device 340 and/or online banking computing platform 310).

In some instances, the one or more login credentials associated with the online banking user account associated with the customer of the financial institution may include a one-time passcode provided to a registered device associated with the customer of the financial institution. For example, in authenticating the user of the mobile computing device (e.g., customer mobile device 340) to the online banking user account associated with the customer of the financial institution, online banking computing platform 310 may prompt the user of customer mobile device 340 to provide a one-time passcode (which may, e.g., be sent by online banking computing platform 310 via a text message, an email, and/or the like to a computing device that has been registered with online banking computing platform 310 as belonging to the customer of the financial institution). Online banking computing platform 310 may, for example, prompt the user of customer mobile device 340 in this manner by generating and/or sending one or more prompts to customer mobile device 340 that are configured to cause customer mobile device 340 to prompt the user of customer mobile device 340 to input and/or otherwise provide such a one-time passcode and/or one or more other login credentials for validation by customer mobile device 340 and/or online banking computing platform 310).

In some instances, the one or more login credentials associated with the online banking user account associated with the customer of the financial institution may include one or more biometrics associated with the customer of the financial institution. For example, in authenticating the user of the mobile computing device (e.g., customer mobile device 340) to the online banking user account associated with the customer of the financial institution, online banking computing platform 310 may prompt the user of customer mobile device 340 to provide one or more biometrics for the online banking account that corresponds to the customer of the financial institution (e.g., by generating and/or sending one or more prompts to customer mobile device 340 that are configured to cause customer mobile device 340 to prompt the user of customer mobile device 340 to input and/or otherwise provide one or more biometrics and/or one or more other login credentials for validation by customer mobile device 340 and/or online banking computing platform 310). Such biometrics may, for instance, include one or more fingerprints that are registered with customer mobile device 340 and/or online banking computing platform 310 as belonging to and/or otherwise associated with the customer of the financial institution, one or more voiceprints that are registered with customer mobile device 340 and/or online banking computing platform 310 as belonging to and/or otherwise associated with the customer of the financial institution, one or more facial and/or retinal images that are registered with customer mobile device 340 and/or online banking computing platform 310 as belonging to and/or otherwise associated with the customer of the financial institution, and/or the like.

Referring again to FIG. 4A, at step 405, online banking computing platform 310 may generate a code generation key. For example, based on authenticating the user of the mobile computing device (e.g., customer mobile device 340) to the online banking user account associated with the customer of the financial institution, online banking computing platform 310 may generate a code generation key configured to be used by the passcode generator on the mobile computing device (e.g., customer mobile device 340) in generating one or more one-time passcodes on the mobile computing device (e.g., customer mobile device 340). The code generation key may, for example, be an arbitrary byte-string, such as a six-digit or eight-digit number, and online banking computing platform 310 may generate the code generation key by using and/or executing a random number generation algorithm or function (which may, e.g., generate the six-digit or eight-digit number as a function of current system time on online banking computing platform 310 and/or one or more other variables, such as an identifier associated with customer mobile device 340). Such a random number generation algorithm or function may, for instance, be provided by a runtime framework and/or application programming interface implemented by and/or otherwise associated with an operating system and/or other computer software of online banking computing platform 310. In this manner, after authenticating the user of customer mobile device 340 to the online banking account of the customer of the financial institution, online banking computing platform 310 may generate a code generation key for a passcode generator application on customer mobile device 340, and the code generation key may be created based on and/or otherwise be specific to customer mobile device 340 and/or the user of customer mobile device 340.

Referring to FIG. 4B, at step 406, online banking computing platform 310 may store the code generation key. For example, at step 406, online banking computing platform 310 may store the code generation key in a key database configured to maintain one or more secret keys for validating one-time passcodes generated by customers of the financial institution. For instance, in storing the code generation key at step 406, online banking computing platform 310 may store the code generation key in key database 315, so as to persist and/or otherwise maintain a copy of the code generation key on a server-side database of online banking computing platform 310.

At step 407, online banking computing platform 310 may send the code generation key to customer mobile device 340. For example, at step 407, online banking computing platform 310 may send, via the communication interface (e.g., communication interface 316), and to the mobile computing device (e.g., customer mobile device 340) associated with the customer of the financial institution, the code generation key to provision the passcode generator on the mobile computing device (e.g., customer mobile device 340) associated with the customer of the financial institution with the code generation key. For instance, at step 407, online banking computing platform 310 may send the code generation key to customer mobile device 340 to provision the passcode generator on customer mobile device 340 with the code generation key, as upon receiving the code generation key from online banking computing platform 310, customer mobile device 340 may store the code generation key and subsequently use the code generation key in generating one or more one-time passcodes, as illustrated in greater detail below.

At step 408, customer mobile device 340 may receive the code generation key from online banking computing platform 310. At step 409, customer mobile device 340 may store the code generation key. For example, at step 409, customer mobile device 340 may store the code generation key in a local repository on customer mobile device 340, so as to persist and/or otherwise maintain the code generation key in a client-side database on customer mobile device 340.

At step 410, online banking computing platform 310 may receive an access request from a customer computing device (e.g., customer computing device 330, customer mobile device 340, or another device). For example, at step 410, online banking computing platform 310 may receive, via the communication interface (e.g., communication interface 316), and from a customer computing device, a request to access the online banking user account associated with the customer of the financial institution. In some instances, the customer computing device may be the mobile computing device associated with the customer of the financial institution. For example, in these instances, online banking computing platform 310 may, at step 410, receive the request to access the online banking user account associated with the customer of the financial institution from the mobile computing device associated with the customer of the financial institution (e.g., customer mobile device 340). In other instances, the customer computing device may be a computing device different from the mobile computing device associated with the customer of the financial institution. For example, in these instances, online banking computing platform 310 may, at step 410, receive the request to access the online banking user account associated with the customer of the financial institution from a computing device different from the mobile computing device associated with the customer of the financial institution, such as customer computing device 330 (which may, e.g., be a different computing device than customer mobile device 340, but which may be used by the same person as customer mobile device 340).

Referring to FIG. 4C, at step 411, online banking computing platform 310 may prompt the customer computing device for one or more login credentials. For example, at step 411, online banking computing platform 310 may generate and/or send one or more messages to the customer computing device (e.g., customer mobile device 340, customer computing device 330) that are configured to cause the customer computing device to prompt the user of the customer computing device to enter and/or otherwise provide one or more login credentials for validation by online banking computing platform 310. At step 412, online banking computing platform 310 may validate the one or more login credentials received from the customer computing device. For example, at step 412, online banking computing platform 310 may validate the one or more login credentials received from the customer computing device (e.g., customer mobile device 340, customer computing device 330) by determining, based on one or more databases and/or records identifying valid login credentials, whether the one or more login credentials received from the customer computing device are valid. If such credentials are invalid, online banking computing platform 310 may generate and/or send one or more error messages to the customer computing device (e.g., customer mobile device 340, customer computing device 330) and the event sequence may end (e.g., at step 412). Alternatively, if such credentials are valid, the event sequence may continue to step 413.

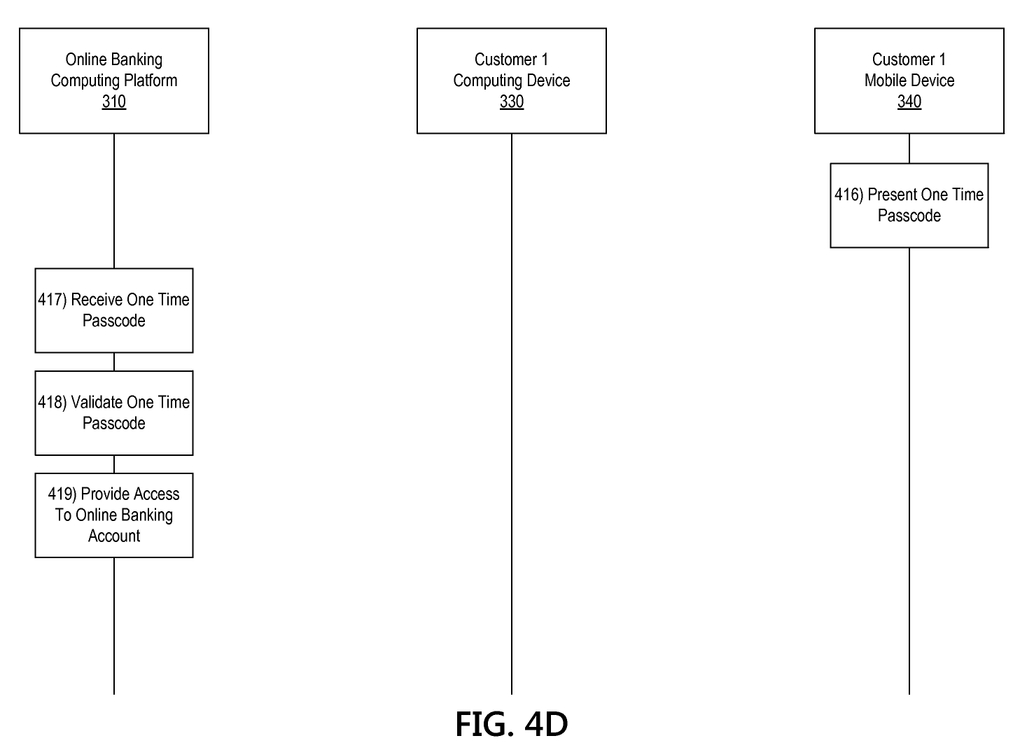

At step 413, online banking computing platform 310 may prompt the customer computing device for a one-time passcode. For example, based on receiving the request to access the online banking user account associated with the customer of the financial institution, online banking computing platform 310 may, at step 413, prompt the customer computing device to provide a one-time passcode generated by the passcode generator on the mobile computing device. For instance, at step 413, online banking computing platform 310 may generate and/or send one or more messages to the customer computing device (e.g., customer mobile device 340, customer computing device 330) that are configured to cause the customer computing device to prompt the user of the customer computing device to enter and/or otherwise provide a one-time passcode for validation by online banking computing platform 310. In some instances, in prompting the customer computing device for a one-time passcode, online banking computing platform 310 may cause the customer computing device (e.g., customer mobile device 340, customer computing device 330) to present one or more graphical user interfaces prompting the user of the customer computing device (e.g., customer mobile device 340, customer computing device 330) to enter and/or otherwise input a one-time passcode. For example, online banking computing platform 310 may cause the customer computing device (e.g., customer mobile device 340, customer computing device 330) to display, cause to be displayed, and/or otherwise present a graphical user interface similar to graphical user interface 700, which is illustrated in FIG. 7. As seen in FIG. 7, graphical user interface 700 may include text and/or other information providing instructions to the user of the customer computing device (e.g., customer mobile device 340, customer computing device 330) to generate a one-time passcode with the passcode generator application on customer mobile device 340 and enter and/or otherwise input the one-time passcode in a designated form field of graphical user interface 700.

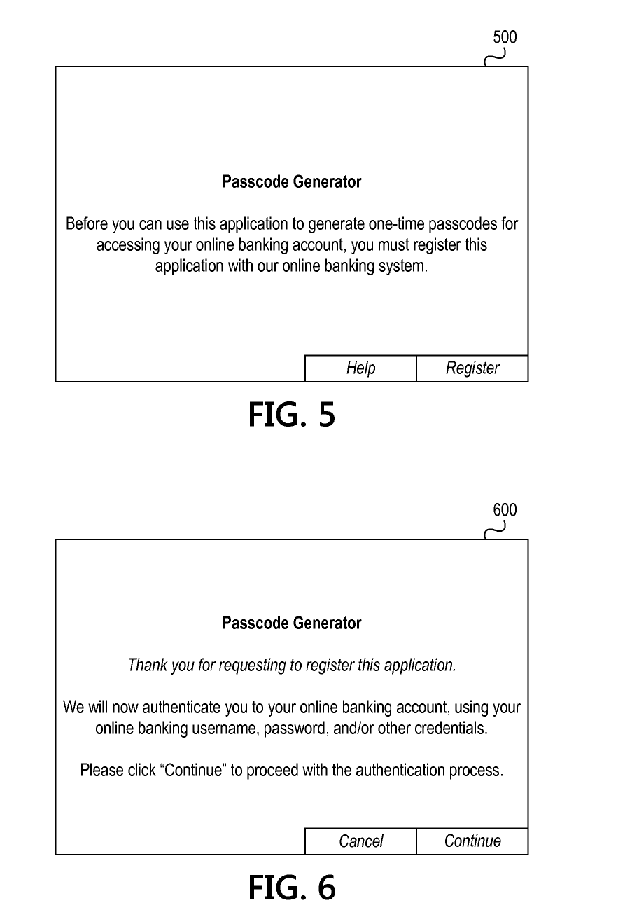

Referring again to FIG. 4C, at step 414, customer mobile device 340 may receive input requesting a one-time passcode. For example, at step 414, customer mobile device 340 may receive input requesting a one-time passcode via the passcode generator application on customer mobile device 340 and/or via one or more graphical user interfaces that may be displayed by and/or otherwise associated with the passcode generator application on customer mobile device 340. For instance, in receiving such input at step 414, customer mobile device 340 may display, cause to be displayed, and/or otherwise present a graphical user interface similar to graphical user interface 800, which is illustrated in FIG. 8. As seen in FIG. 8, graphical user interface 800 may include text and/or other information providing instructions to the user of customer mobile device 340 regarding generating a one-time passcode using the passcode generator application on customer mobile device 340.

Referring again to FIG. 4C, at step 415, customer mobile device 340 may generate a one-time passcode. For example, at step 415, customer mobile device 340 may generate a one-time passcode using the passcode generator application and the code generation key provided to customer mobile device 340 by online banking computing platform 310. In some instances, the passcode generator application on customer mobile device 340 may generate a one-time passcode based on the code generation key using one or more OATH-compliant passcode generation algorithms. Such algorithms (which may, e.g., be executed by customer mobile device 340 and/or by the passcode generator application on customer mobile device 340) may, for instance, generate a passcode as a function of the code generation key and a current time value and/or a current counter value. For example, customer mobile device 340 and/or the passcode generator application on customer mobile device 340 may use a time-based one-time passcode generation algorithm (TOTP) to generate a one-time passcode using the code generation key as a secret key in accordance with an OATH standard. Alternatively, customer mobile device 340 and/or the passcode generator application on customer mobile device 340 may use a counter-based one-time passcode generation algorithm (HOTP) to generate a one-time passcode using the code generation key as a secret key in accordance with an OATH standard.

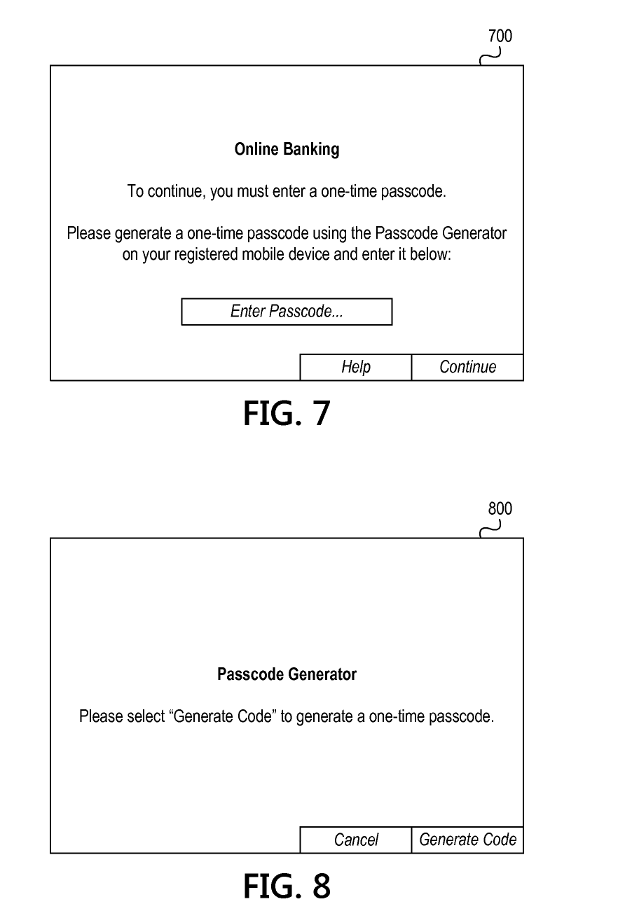

Referring to FIG. 4D, at step 416, customer mobile device 340 may present the one-time passcode generated at step 415. For example, at step 416, customer mobile device 340 may present the one-time passcode via one or more graphical user interfaces that may be displayed by and/or otherwise associated with the passcode generator application on customer mobile device 340. For instance, in presenting the one-time passcode at step 416, customer mobile device 340 may display, cause to be displayed, and/or otherwise present a graphical user interface similar to graphical user interface 900, which is illustrated in FIG. 9. As seen in FIG. 9, graphical user interface 900 may include text and/or other information specifying and/or identifying the one-time passcode (which may, e.g., have been generated by customer mobile device 340 at step 415, as discussed above).

Referring again to FIG. 4D, at step 417, online banking computing platform 310 may receive a one-time passcode from the customer computing device. For example, at step 417, online banking computing platform 310 may receive, via the communication interface (e.g., communication interface 316), and from the customer computing device (e.g., customer mobile device 340, customer computing device 330), a first one-time passcode generated by the passcode generator on the mobile computing device (e.g., customer mobile device 340). For instance, the user of the customer computing device (e.g., customer mobile device 340, customer computing device 330) may input to the customer computing device (e.g., customer mobile device 340, customer computing device 330) the one-time passcode generated by customer mobile device 340 (e.g., at step 415), and the customer computing device (e.g., customer mobile device 340, customer computing device 330) may send this one-time passcode to online banking computing platform 310 for validation. In some instances, online banking computing platform 310 may thus receive the one-time passcode at step 417 from customer mobile device 340, while in other instances, online banking computing platform 310 may receive the one-time passcode at step 417 from customer computing device 330 or from a different computing device.

At step 418, online banking computing platform 310 may validate the one-time passcode received from the customer computing device. For example, at step 418, online banking computing platform 310 may validate the first one-time passcode generated by the passcode generator on the mobile computing device (e.g., customer mobile device 340) based on the code generation key stored in the key database (e.g., key database 315). In validating the one-time passcode received from the customer computing device (e.g., customer mobile device 340, customer computing device 330), online banking computing platform 310 may, for instance, generate a validation passcode based on the code generation key using one or more OATH-compliant passcode generation algorithms (e.g., similar to how customer mobile device 340 may generate the one-time passcode based on the code generation key, as discussed above) and subsequently may determine whether the validation passcode generated by online banking computing platform 310 matches the one-time passcode generated by customer mobile device 340 and received from the customer computing device (e.g., customer mobile device 340, customer computing device 330). If the validation passcode generated by online banking computing platform 310 does not match the one-time passcode generated by customer mobile device 340 and received from the customer computing device (e.g., customer mobile device 340, customer computing device 330), then online banking computing platform 310 may generate and/or send one or more error messages to the customer computing device (e.g., customer mobile device 340, customer computing device 330) and the event sequence may end. In this way, if the one-time passcode received from the customer computing device (e.g., customer mobile device 340, customer computing device 330) is invalid, online banking computing platform 310 may deny access to the online banking account to the customer computing device (e.g., customer mobile device 340, customer computing device 330). Alternatively, if the validation passcode generated by online banking computing platform 310 does match the one-time passcode generated by customer mobile device 340 and received from the customer computing device (e.g., customer mobile device 340, customer computing device 330), then the event sequence may continue to step 419.

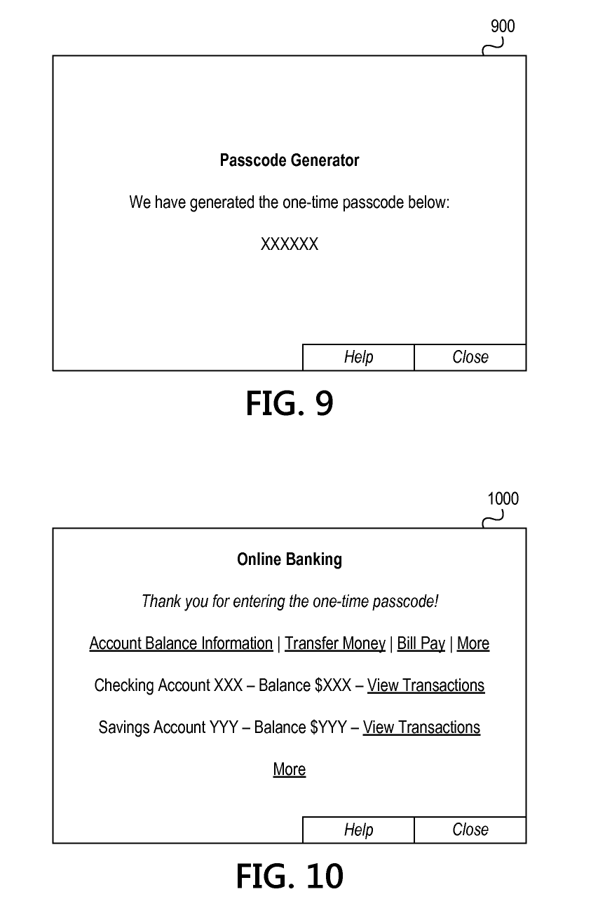

At step 419, online banking computing platform 310 may provide the customer computing device with access to an online banking account. For example, based on validating the first one-time passcode generated by the passcode generator on the mobile computing device (e.g., customer mobile device 340) based on the code generation key stored in the key database (e.g., key database 315), online banking computing platform 310 may, at step 419, provide the customer computing device (e.g., customer mobile device 340, customer computing device 330) with access to the online banking user account associated with the customer of the financial institution. In providing the customer computing device (e.g., customer mobile device 340, customer computing device 330) with access to the online banking user account associated with the customer of the financial institution, online banking computing platform 310 may, for instance, enable, allow, and/or provide the customer computing device (e.g., customer mobile device 340, customer computing device 330) and/or the user of the customer computing device (e.g., customer mobile device 340, customer computing device 330) with access to financial account information, transaction history information, and/or other information associated with the online banking user account (which may, e.g., maintained by online banking computing platform 310 and/or by the financial institution operating online banking computing platform 310 for the customer of the financial institution). In some instances, in providing the customer computing device (e.g., customer mobile device 340, customer computing device 330) with access to the online banking user account, online banking computing platform 310 may cause the customer computing device (e.g., customer mobile device 340, customer computing device 330) to present one or more graphical user interfaces that include information associated with the online banking user account. For example, online banking computing platform 310 may cause the customer computing device (e.g., customer mobile device 340, customer computing device 330) to display, cause to be displayed, and/or otherwise present a graphical user interface similar to graphical user interface 1000, which is illustrated in FIG. 10. As seen in FIG. 10, graphical user interface 1000 may include text and/or other information associated with the online banking user account, such as financial account information and/or one or more links to access account balance information, transaction history information, funds transfer functions, online bill payment functions, and/or other functions and/or other information.

In some embodiments, providing the customer computing device with access to the online banking user account associated with the customer of the financial institution may include providing financial account information to the customer computing device via an online banking portal. For example, in providing the customer computing device (e.g., customer mobile device 340, customer computing device 330) with access to the online banking user account associated with the customer of the financial institution, online banking computing platform 310 may provide financial account information to the customer computing device (e.g., customer mobile device 340, customer computing device 330) via an online banking portal. Such an online banking portal may, for instance, include one or more pages and/or other user interfaces that, in some instances, may resemble graphical user interface 1000, which is illustrated in FIG. 10 and discussed in greater detail above.

In some embodiments, providing the customer computing device with access to the online banking user account associated with the customer of the financial institution may include processing one or more transaction requests received from the customer computing device via the online banking portal. For example, in providing the customer computing device (e.g., customer mobile device 340, customer computing device 330) with access to the online banking user account associated with the customer of the financial institution, online banking computing platform 310 may process one or more transaction requests received from the customer computing device (e.g., customer mobile device 340, customer computing device 330) via the online banking portal. Such transaction requests may, for instance, be created by the customer computing device (e.g., customer mobile device 340, customer computing device 330) and/or by the user of the customer computing device (e.g., customer mobile device 340, customer computing device 330) using one or more money transfer functions, one or more bill payment functions, and/or one or more other functions that may be provided by and/or otherwise available via the online banking portal.

In some embodiments, at least one transaction request of the one or more transaction requests received from the customer computing device via the online banking portal may include a request for a restricted transaction that requires validation of the first one-time passcode generated by the passcode generator on the mobile computing device. For example, one or more of the transaction requests received from the customer computing device (e.g., customer mobile device 340, customer computing device 330) via the online banking portal may include a request for a restricted transaction that requires validation of the one-time passcode generated by the passcode generator on customer mobile device 340. Such a restricted transaction may, for instance, be and/or correspond to a request an amount of funds above a predetermined threshold amount (which may, e.g., be considered a relatively high-value transaction), a request to transfer funds to an account maintained by a different financial institution than the financial institution operating online banking computing platform 310, a request to transfer funds to a different country than the country in which the customer's financial account is maintained, or the like. In such instances, online banking computing platform 310 may prompt the customer computing device (e.g., customer mobile device 340, customer computing device 330) and/or the user of the customer computing device (e.g., customer mobile device 340, customer computing device 330) to generate, enter, and/or otherwise provide a new one-time passcode for validation by online banking computing platform 310 (e.g., similar to how online banking computing platform 310 may prompt the customer computing device (e.g., customer mobile device 340, customer computing device 330) and/or the user of the customer computing device (e.g., customer mobile device 340, customer computing device 330) to generate, enter, and/or otherwise provide a one-time passcode as discussed above). Additionally or alternatively, online banking computing platform 310 may prompt the customer computing device (e.g., customer mobile device 340, customer computing device 330) and/or the user of the customer computing device (e.g., customer mobile device 340, customer computing device 330) to enter and/or otherwise input the previously-generated one-time passcode (which may, e.g., have been generated by customer mobile device 340 at step 415 as discussed above).

In some instances, one or more steps of the event sequence illustrated in FIGS. 4A-4D may be repeated, for instance, during a subsequent request involving customer computing device 330 and/or customer mobile device 340 requesting access and/or account information from online banking computing platform 310. Additionally or alternatively, one or more steps of the event sequence illustrated in FIGS. 4A-4D may be repeated with customer computing device 350 and customer mobile device 360 performing similar steps as customer computing device 330 and customer mobile device 340, respectively, so as to provision customer mobile device 360 with a code generation key. This may, for instance, enable the user of customer mobile device 360 (who may, e.g., be a different customer of the financial institution operating online banking computing platform 310 than the customer who may use customer mobile device 340) to similarly generate one or more one-time passcodes and access their own online banking account via online banking computing platform 310 in a similar manner as discussed above.

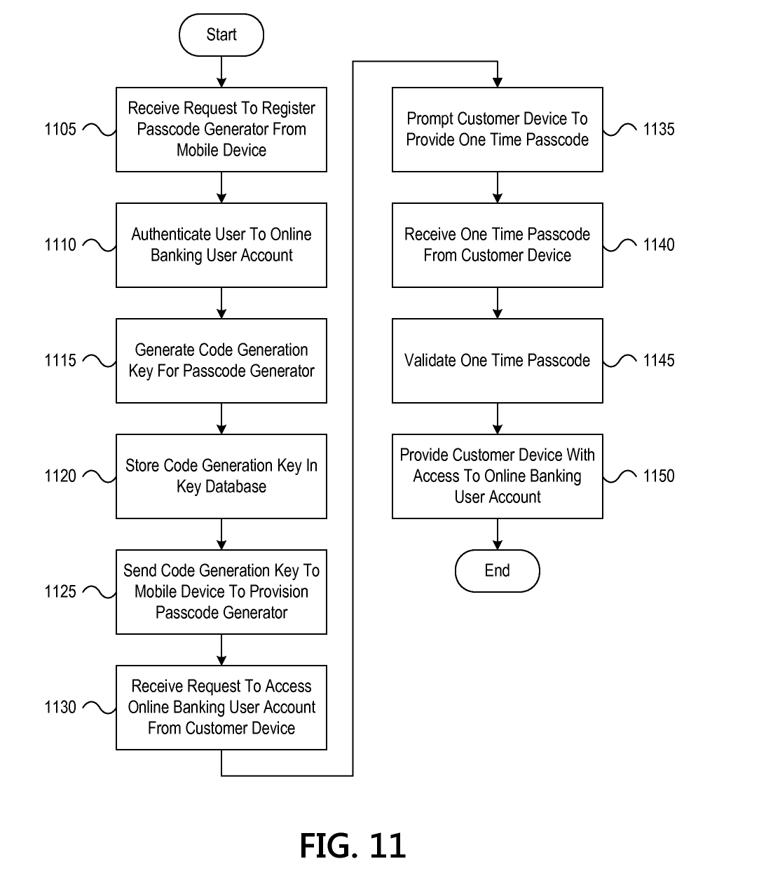

FIG. 11 depicts an illustrative method for provisioning a mobile device with a code generation key to enable generation of one-time passcodes in accordance with one or more example embodiments. Referring to FIG. 11, at step 1105, a computing platform may receive a request to register a passcode generator from a mobile device. At step 1110, the computing platform may authenticate a user of the mobile device to an online banking user account. At step 1115, the computing platform may generate a code generation key for the passcode generator. At step 1120, the computing platform may store the code generation key in a key database. At step 1125, the computing platform may send the code generation key to the mobile device to provision the passcode generator. At step 1130, the computing platform may receive a request to access the online banking user account from a customer device. At step 1135, the computing platform may prompt the customer device to provide a one-time passcode. At step 1140, the computing platform may receive a one-time passcode from the customer device. At step 1145, the computing platform may validate the one-time passcode. At step 1150, the computing platform may provide the customer device with access to the online banking user account.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
at least one processor;
a communication interface communicatively coupled to the at least one processor; and
memory storing computer-readable instructions that, when executed by the at least one processor, cause the system to:
receive, via the communication interface, and from a mobile computing device associated with a customer of a financial institution, a request to register a passcode generator on the mobile computing device;
based on receiving the request to register the passcode generator on the mobile computing device, authenticate a user of the mobile computing device to an online banking user account associated with the customer of the financial institution;
based on authenticating the user of the mobile computing device to the online banking user account associated with the customer of the financial institution, generate a code generation key configured to be used by the passcode generator on the mobile computing device in generating one or more one-time passcodes on the mobile computing device;
store the code generation key in a key database configured to maintain one or more secret keys for validating one-time passcodes generated by customers of the financial institution; and
send, via the communication interface, and to the mobile computing device associated with the customer of the financial institution, the code generation key to provision the passcode generator on the mobile computing device associated with the customer of the financial institution with the code generation key.

2. The system of claim 1, wherein authenticating the user of the mobile computing device to the online banking user account associated with the customer of the financial institution comprises:
prompting the user of the mobile computing device to provide one or more login credentials associated with the online banking user account associated with the customer of the financial institution; and
validating the one or more login credentials provided by the user of the mobile computing device.

3. The system of claim 2, wherein the one or more login credentials associated with the online banking user account associated with the customer of the financial institution include a username and password.

4. The system of claim 2, wherein the one or more login credentials associated with the online banking user account associated with the customer of the financial institution include a one-time passcode provided to a registered device associated with the customer of the financial institution.

5. The system of claim 2, wherein the one or more login credentials associated with the online banking user account associated with the customer of the financial institution include one or more biometrics associated with the customer of the financial institution.

6. The system of claim 1, wherein the memory stores additional computer-readable instructions that, when executed by the at least one processor, further cause the system to:
receive, via the communication interface, and from a customer computing device, a request to access the online banking user account associated with the customer of the financial institution; and
based on receiving the request to access the online banking user account associated with the customer of the financial institution, prompt the customer computing device to provide a one-time passcode generated by the passcode generator on the mobile computing device.

7. The system of claim 6, wherein the memory stores additional computer-readable instructions that, when executed by the at least one processor, further cause the system to:
receive, via the communication interface, and from the customer computing device, a first one-time passcode generated by the passcode generator on the mobile computing device;
validate the first one-time passcode generated by the passcode generator on the mobile computing device based on the code generation key stored in the key database; and
based on validating the first one-time passcode generated by the passcode generator on the mobile computing device based on the code generation key stored in the key database, provide the customer computing device with access to the online banking user account associated with the customer of the financial institution.

8. The system of claim 7, wherein providing the customer computing device with access to the online banking user account associated with the customer of the financial institution comprises providing financial account information to the customer computing device via an online banking portal.

9. The system of claim 8, wherein providing the customer computing device with access to the online banking user account associated with the customer of the financial institution comprises processing one or more transaction requests received from the customer computing device via the online banking portal.

10. The system of claim 9, wherein at least one transaction request of the one or more transaction requests received from the customer computing device via the online banking portal comprises a request for a restricted transaction that requires validation of the first one-time passcode generated by the passcode generator on the mobile computing device.

11. The system of claim 6, wherein the customer computing device is the mobile computing device associated with the customer of the financial institution.

12. The system of claim 6, wherein the customer computing device is a computing device different from the mobile computing device associated with the customer of the financial institution.

13. A method, comprising:
at a computing platform comprising at least one processor, memory, and a communication interface:
receiving, by the at least one processor, via the communication interface, and from a mobile computing device associated with a customer of a financial institution, a request to register a passcode generator on the mobile computing device;
based on receiving the request to register the passcode generator on the mobile computing device, authenticating, by the at least one processor, a user of the mobile computing device to an online banking user account associated with the customer of the financial institution;
based on authenticating the user of the mobile computing device to the online banking user account associated with the customer of the financial institution, generating, by the at least one processor, a code generation key configured to be used by the passcode generator on the mobile computing device in generating one or more one-time passcodes on the mobile computing device;
storing, by the at least one processor, the code generation key in a key database configured to maintain one or more secret keys for validating one-time passcodes generated by customers of the financial institution; and
sending, by the at least one processor, via the communication interface, and to the mobile computing device associated with the customer of the financial institution, the code generation key to provision the passcode generator on the mobile computing device associated with the customer of the financial institution with the code generation key.

14. The method of claim 13, wherein authenticating the user of the mobile computing device to the online banking user account associated with the customer of the financial institution comprises:
prompting the user of the mobile computing device to provide one or more login credentials associated with the online banking user account associated with the customer of the financial institution; and
validating the one or more login credentials provided by the user of the mobile computing device.

15. The method of claim 14, wherein the one or more login credentials associated with the online banking user account associated with the customer of the financial institution include a username and password.

16. The method of claim 14, wherein the one or more login credentials associated with the online banking user account associated with the customer of the financial institution include a one-time passcode provided to a registered device associated with the customer of the financial institution.

17. The method of claim 14, wherein the one or more login credentials associated with the online banking user account associated with the customer of the financial institution include one or more biometrics associated with the customer of the financial institution.

18. The method of claim 13, further comprising:
receiving, by the at least one processor, via the communication interface, and from a customer computing device, a request to access the online banking user account associated with the customer of the financial institution; and
based on receiving the request to access the online banking user account associated with the customer of the financial institution, prompting, by the at least one processor, the customer computing device to provide a one-time passcode generated by the passcode generator on the mobile computing device.

19. The method of claim 18, further comprising:
receiving, by the at least one processor, via the communication interface, and from the customer computing device, a first one-time passcode generated by the passcode generator on the mobile computing device;
validating, by the at least one processor, the first one-time passcode generated by the passcode generator on the mobile computing device based on the code generation key stored in the key database; and
based on validating the first one-time passcode generated by the passcode generator on the mobile computing device based on the code generation key stored in the key database, providing, by the at least one processor, the customer computing device with access to the online banking user account associated with the customer of the financial institution.

20. One or more non-transitory computer-readable media storing instructions that, when executed by a computer system comprising at least one processor, memory, and a communication interface, cause the computer system to:
receive, via the communication interface, and from a mobile computing device associated with a customer of a financial institution, a request to register a passcode generator on the mobile computing device;
based on receiving the request to register the passcode generator on the mobile computing device, authenticate a user of the mobile computing device to an online banking user account associated with the customer of the financial institution;
based on authenticating the user of the mobile computing device to the online banking user account associated with the customer of the financial institution, generate a code generation key configured to be used by the passcode generator on the mobile computing device in generating one or more one-time passcodes on the mobile computing device;
store the code generation key in a key database configured to maintain one or more secret keys for validating one-time passcodes generated by customers of the financial institution; and
send, via the communication interface, and to the mobile computing device associated with the customer of the financial institution, the code generation key to provision the passcode generator on the mobile computing device associated with the customer of the financial institution with the code generation key.
